(19) United States
(12) Patent Application Publication
(10) Pub. No.: US 2026/0243920 A1
(43) Pub. Date: Aug. 20, 2026

(54) METHODS FOR IDENTIFYING ICING ZONES OF TYPICAL MICRO-TERRAIN AND MICRO-CLIMATE ON TRANSMISSION LINES

(71) Applicants: State Grid Henan Electric Power Research institute, Zhengzhou (CN); Chongqing Dige Technology Co., Ltd., Chongqing (CN)

(72) Inventors: Degui Yao, Zhengzhou (CN); Jinyu Wang, Zhengzhou (CN); Xingliang Jiang, Chongqing (CN); Zhe Li, Zhengzhou (CN); Guolin Yang, Chongqing (CN); Jiaying Ke, Zhengzhou (CN); Lina Dong, Chongqing (CN); Yun Liang, Zhengzhou (CN); Lu Zhang, Zhengzhou (CN); Kai Pang, Zhengzhou (CN); Chao Wang, Zhengzhou (CN); Ming Lu, Zhengzhou (CN); Sikun Yuan, Zhengzhou (CN); Yang Gao, Zhengzhou (CN); Shuai Li, Zhengzhou (CN); Jingjing Cui, Zhengzhou (CN); Zhuojun Li, Chongqing (CN)

(73) Assignees: State Grid Henan Electric Power Research institute, Zhengzhou (CN); Chongqing Dige Technology Co., Ltd., Chongqing (CN)

(21) Appl. No.: 19/643,244

(22) Filed: Apr. 9, 2026

Related U.S. Application Data
(63) Continuation of application No. PCT/CN2025/140874, filed on Dec. 8, 2025.

(30) Foreign Application Priority Data
Dec. 9, 2024 (CN) 2024118007371

(51) Int. Cl. G01W 1/02; G06F 17/14

(52) U.S. Cl. CPC G01W 1/02; G06F 17/145

(57) ABSTRACT

A method for identifying icing zones of typical micro-terrain and micro-climate on transmission lines, including: Step 1, generating a DEM map with a range of 1.5 km×1.5 km centered on the tower's latitude and longitude; Step 2, filtering the DEM map; Step 3, extracting typical terrain feature factors of the icing zone using the maximum gradient algorithm based on the DEM map obtained in Step 2; Step 4, performing basic calculations based on the terrain feature factors in Step 3; Step 5, analyzing the terrain features to propose quantitative values applicable to each micro-terrain and micro-climate zone, determining whether there are high mountain watersheds, terrain uplift, mountain passes, canyon wind corridors, and increased water vapor; thus solving the problem of identifying icing conditions in different types of micro-terrain and micro-climate transmission lines.

### RELATED APPLICATIONS

The present application document is a continuation of PCT Application Serial No. PCT/CN 2025/140874, filed Dec. 8, 2025, which claims the benefit of priority to CN Patent Application No. 2024118007371, filed Dec. 9, 2024, and entitled “A method for identifying icing zones of typical Micro-terrain and Micro-climate on transmission lines”, designating the United States and published in English, which both are hereby incorporated by reference.

### FIELD

This disclosure belongs to the field of transmission line icing monitoring technology, and particularly relates to a method for identifying icing zones of typical micro-terrain and micro-climate on transmission lines.

### BACKGROUND

Icing on transmission lines has become a long-term threat to the safety of power grid operation. Icing-related accidents such as tower collapse, conductor breakage, and insulator string flash-over occur frequently, leading to large-scale power outages and even system collapse, seriously affecting people's normal lives and causing extremely serious damage to the power system. To avoid ice disasters, monitoring of icing on transmission lines is of paramount importance.

Since the 1950s, researchers both domestically and internationally have conducted in-depth theoretical studies on transmission line icing, reaching systematic conclusions regarding its causes and principles. However, many researchers have gradually realized the importance of considering the impact of micro-terrain and micro-climates on transmission line icing and have attempted to combine meteorological and topographical analysis. While many researchers have conducted research on the impact of specific meteorological or topographical factors, few have combined the influence of topography on meteorology to conduct research on terrain identification. Micro-terrain and micro-climate zones are mostly located in remote areas with underdeveloped transportation, resulting in limited field survey data. The definition and identification methods of micro-terrain and micro-climates remain poorly understood, and universally applicable research conclusions have not been derived through theoretical and quantitative analysis. Existing transmission line anti-icing designs rarely consider icing conditions within a 100-meter radius of micro-terrain and micro-climate zones, leaving areas such as high mountains, mountain passes, and canyons as design blind spots. Therefore, it is necessary to classify and identify these micro-terrain and micro-climate zones and conduct targeted research for each category.

Research on micro-terrain and micro-climate regional classification and identification methods helps to adopt reasonable anti-icing, prevent-icing, and de-icing technologies, providing strong technical support for power grid icing prevention and disaster reduction, ensuring the safe operation of energy transmission channels, improving the power grid's ability to withstand disasters, and guaranteeing the electricity needs of the whole society. For long-distance transmission lines, especially ultra-high-voltage transmission lines, differentiated anti-icing designs can be implemented based on the icing conditions of different types of micro-terrain and micro-climate sections. This will effectively improve the reliability of power supply and the economic efficiency of power grid operation, and has important guiding significance for power grid ice-melting and anti-icing work.

### SUMMARY

The technical problem this disclosure aims to solve is to provide a method for identifying icing zones of typical micro-terrain and micro-climate on transmission lines, thereby classifying and identifying micro-terrain and micro-climate regions and providing differentiated anti-icing design suggestions for long-distance transmission lines, especially ultra-high voltage transmission lines.

Technical solution of the present disclosure:

A method for identifying icing zones of typical micro-terrain and micro-climate on power transmission lines, the method comprising:
Step 1, generating a DEM map covering a 1.5 km×1.5 km area centered on the pole's latitude and longitude based on the pole's latitude and longitude;
Step 2: filtering the DEM image;
Step 3: utilizing maximum slope gradient algorithm to extract typical terrain feature factors of the icy area based on the DEM map obtained in Step 2,
Step 4: performing basic calculations based on the terrain feature factors in Step 3;
Step 5: analyzing and proposing quantitative values applicable to each micro-terrain and micro-climate region to determine the presence of high mountain watersheds, terrain uplift, mountain passes, canyon wind corridors, and an increase in water vapor based on terrain features;
the step for generating a DEM map with a range of 1.5 km×1.5 km centered on the pole's latitude and longitude further includes:
based on geographic information data and basic definitions, determining the altitude of the pole's location, the slope of the surrounding hillsides, the mountain top, the mountain bottom, and water features as basic reference features for classification and identification, constructing a matrix database, and generating a DEM map with a range of 1.5 km×1.5 km centered on the pole's latitude and longitude.
the step for filtering DEM maps further include:
utilizing median filtering to fill in missing values and to improve the quality of DEM data.
terrain feature factor extraction further includes: slope and aspect extraction and slope variability and aspect variability extraction.
terrain feature factor extraction further includes: slope and aspect extraction and slope variability and aspect variability extraction.
utilizing Hough transform method to analyze terrain features. proposing quantization values applicable to various micro-terrain and micro-climate regions to determine the presence of high-mountain watersheds, terrain uplift, mountain passes, canyon wind corridors, and increased water vapor, including:
utilizing the quantization results parameters of the above-mentioned features quantities to determine; wherein
the quantization results parameters of the features quantities including:
I). elevation difference: calculating the elevation difference for four types of micro-terrain and micro-climate regions: high-mountain watersheds, terrain uplift, mountain passes, and canyon wind corridors;
II). terrain uplift: calculating the slope ratio for these four types of micro-terrain, with only the largest slope ratio selected for terrain uplift;
III). mountain pass: based on the above calculations, a mountain pass with a height exceeding 150 m, an elevation difference greater than 121 m, and a horizontal distance of not less than [missing value] between the highest and lowest points. 150 m, with mountain slope ratios |tanα| and |tanβ| greater than 37%;
IV). canyon wind tunnel: based on the above calculation results, the height of the canyon wind tunnel type mountain is over 100 m, the elevation difference is greater than 81 m, the horizontal distance between the highest and lowest points is not less than 150 m, and the mountain slope ratios |tanα| and |tanβ| are greater than 44%;
V). increased water vapor: the tower of the water vapor increase type is less than 1000 m away from the water body, and the width of the water body is over 50 m, and the area is over 1 km².
The beneficial effects of this disclosure are:

This disclosure combines terrain elements used to describe land-form types, employing median filtering to fill in missing values and to improve data quality in the original data. The disclosure selects appropriate algorithms to effectively extract implicit terrain factors such as slope, aspect, curvature, variability, and terrain relief, as well as terrain feature lines such as valley lines and ridge lines, and terrain feature points such as mountain bases and summits.

Therefore, the disclosure solves the problem of identifying icing conditions on transmission lines sections with different types of micro-terrain and micro-climates.

### BRIEF DESCRIPTION OF THE DRAWINGS

FIG. 1 is a diagram showing the transformation between the original space and Hough space according to a specific embodiment of the present disclosure.

### DETAILED DESCRIPTION

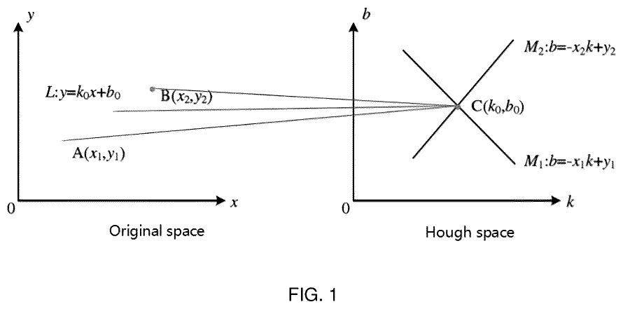

A method for identifying icing zones of typical micro-terrain and micro-climate on power transmission lines, comprising:
Step 1: based on the latitude and longitude of a tower, summarize the general trend of the transmission lines in each type of micro-terrain and micro-climate regions. Based on geographic information data and basic definitions, determine the altitude of the tower's location, the slope of the surrounding hillsides, the top and bottom of the hill, and water-related features as the basic reference features for classification and identification, and construct a matrix database. Generate a DEM map with a range of 1.5 km×1.5 km centered on the latitude and longitude of the tower; the DEM map has functions such as terrain analysis, hydrological simulation, and land use planning.
Step 2: based on the DEM map from Step 1, to improve the accuracy and smoothness of the data and to further analyze the terrain, further process the original data. The distribution of data points varies with the complexity of the terrain; the density of data points refers to the minimum number of data points required to classify land-form types; the accuracy of data points represents the unavoidable errors during data acquisition. Accordingly, median filtering is used to fill in missing values and to improve the quality of the DEM data, performing filtering processing on the original DEM map.
Step 3: based on the processed DEM image obtained in Step 2, utilizing the maximum slope gradient algorithm to extract typical terrain feature factors of the icy area. I). slope and aspect extraction: among the terrain factors, slope and aspect are two parameters used to describe land-form morphology, and they are interrelated. Slope reflects the tilt angle of the mountain, defined as the angle between the normal and the perpendicular line at a point P on the terrain surface, and the calculation range is limited to the cells in the surrounding eight directions. Aspect reflects the direction of the slope, defined as the angle between the positive direction of the normal at a point P in the plane projection and the geographic north direction. II). slope variation and aspect variation extraction: Slope of Slope (SOS) is an indicator that measures the change in slope, while Slope of Aspect (SOA) is an indicator that measures the change in aspect. In practice, slope variation and aspect variation are related to the slope of the linear equation in analytic geometry. In this disclosure, the calculation of slope variability and aspect variability also employs the maximum gradient algorithm, that is, mathematical calculations are performed based on the aforementioned slope and aspect extraction.
Step 4: based on the basic calculations of terrain feature factors performed in Step 3, further analysis of terrain features is needed. Hydrological analysis methods are generally applicable to large areas with distinct features, for the areas studied, a new feature line detection method, the Hough transform, is proposed. The Hough transform detection method relies on image processing and is used for image shape detection. The method has good noise resistance and low detection difficulty, mainly involving the transformation of two spaces: the original space and the Hough space. Two points A(x, y) and B(x, y) in the original space can be connected by a straight line, with the equation y=kx+b; transforming the equation to the Hough space and converting the equation into expressions for k and b, as shown in FIG. 1. In the original space, two points connected by a straight line become a single point when converted to the Hough space; converting multiple points in the original space into multiple straight lines in the Hough space, selecting the point formed by the convergence of as many straight lines as possible. By detecting whether the cumulative number of points in the Hough space reaches a threshold, therefore deriving the equation of the straight line in the original space.
Step 5: Based on analyzing of the terrain features, proposing quantization values applicable to various micro-terrain and micro-climate regions to determine the presence of high-mountain watersheds, terrain uplift, mountain passes, canyon wind corridors, and increased water vapor. A specific method utilizes the quantization results parameters of the above-mentioned features quantities to make the determination. The quantization result parameters of the features quantities include: I). elevation difference: calculate the elevation difference for the four types of micro-terrain and micro-climate regions: high-mountain watersheds, terrain uplift, mountain passes, and canyon wind corridors. II). terrain uplift: calculate the slope ratio for the four types of micro-terrain: high-mountain watersheds, terrain uplift, mountain passes, and canyon wind corridors. For terrain uplift, only the larger slope ratio on one side is selected. III). mountain pass: based on the calculation results of the above sample cases, the mountain height of a mountain pass is generally above 150 m, the elevation difference is greater than 121 m, the horizontal distance between the highest and lowest points is not less than 150 m, and the slope ratios|tanα| and |tanβ| are greater than 37%. IV). canyon wind channel: based on the calculation results of the above sample cases, the height of a canyon wind channel type mountain is generally over 100 m, the elevation difference is greater than 81 m, the horizontal distance between the highest and lowest points is not less than 150 m, and the slope ratios |tanα| and |tanβ| are greater than 44%. V). increased water vapor: in most actual cases, the water systems, such as rivers and lakes, are large bodies of water, with river widths greater than 100 m and water areas greater than 500 km². Based on the calculation results of the above sample cases, the towers of large water vapor-increasing structures are less than 1000 m from the water body, and the water body is more than 50 m wide and has an area greater than 1 km².

1. A method for identifying icing zones of typical micro-terrain and micro-climate on power transmission lines, comprising:
Step 1, generating a DEM map covering a 1.5 km×1.5 km area centered on a pole's latitude and longitude based on the pole's latitude and longitude;
Step 2: filtering the DEM image;
Step 3: utilizing a maximum slope gradient algorithm to extract terrain feature factors of an icy area based on the DEM map obtained in Step 2,
Step 4: performing basic calculations based on the terrain feature factors in Step 3;
Step 5: analyzing and proposing quantization values applicable to each micro-terrain and micro-climate region to determine a presence of high mountain watersheds, terrain uplift, mountain passes, canyon wind corridors, and an increase in water vapor based on terrain features.

2. The method of claim 1, wherein the step for generating a DEM map with a range of 1.5 km×1.5 km centered on the pole's latitude and longitude further includes:
based on geographic information data and basic definitions, determining an altitude of the pole's location, a slope of surrounding hillsides, a mountain top, a mountain bottom, and water features as basic reference features for classification and identification, constructing a matrix database, and generating a DEM map with a range of 1.5 km×1.5 km centered on the pole's latitude and longitude.

3. The method of claim 1, wherein the step for filtering DEM maps further includes:
utilizing median filtering to fill in missing values and to improve a quality of DEM data.

4. The method of claim 1, wherein
the terrain feature factor extraction further includes: slope and aspect extraction and slope variability and aspect variability extraction.

5. The method of claim 1, further comprising:
utilizing Hough transform method to analyze terrain features.

6. The method of claim 1, further comprising:
proposing quantization values applicable to various micro-terrain and micro-climate regions to determine the presence of high-mountain watersheds, terrain uplift, mountain passes, canyon wind corridors, and increased water vapor, including:
utilizing the quantization results parameters of the features quantities to determine; wherein
the quantization results parameters of the features quantities including:
I). elevation difference: calculating an elevation difference for four types of micro-terrain and micro-climate regions: high-mountain watersheds, terrain uplift, mountain passes, and canyon wind corridors;
II). terrain uplift: calculating the slope ratio for these four types of micro-terrain, with only a largest slope ratio selected for terrain uplift;
III). mountain pass: based on the above calculations, a mountain pass with a height exceeding 150 m, an elevation difference greater than 121 m, and a horizontal distance of not less than [missing value] between a highest and lowest points. 150 m, with mountain slope ratios |tanα| and |tanβ| greater than 37%;
IV). canyon wind tunnel: based on the above calculations, a height of the canyon wind tunnel type mountain is over 100 m, the elevation difference is greater than 81 m, the horizontal distance between the highest and lowest points is not less than 150 m, and the mountain slope ratios |tanα| and |tanβ| are greater than 44%;
V). increased water vapor: a tower of the increased water vapor type is less than 1000 m away from a water body, and a width of the water body is over 50 m, and an area is over 1 km².
